(19) United States
(12) Patent Application Publication
(10) Pub. No.: US 2011/0123691 A1
(43) Pub. Date: May 26, 2011

(54) Method and Apparatus for Preparing Tamales

(76) Inventor: Eleuterio Reyna, JR., Bakersfield, CA (US)

(21) Appl. No.: 12/820,097

(22) Filed: Jun. 21, 2010

Related U.S. Application Data
(60) Provisional application No. 61/281,943, filed on Nov. 25, 2009.
(60) Provisional application No. 61/317,887, filed on Mar. 26, 2010.

(51) Int. Cl. A21C 9/06; A21D 8/00; A23P 1/00

(52) U.S. Cl. 426/297; 99/450.6

(57) ABSTRACT

A tamale making apparatus has a rectangular or square portable table where the table has a top surface. The top surface is divided into two areas, the first area for holding a volume of masa, while the second area is for placing an outer wrapping material, such as a corn husk. The first area is utilized for placement of a masa storage compartment, which is formed by three retention members which are configured into a U-shaped compartment, with the open end facing the user. The second area, which is adjacent to the first area, is used for placing a corn husk on the table surface, and placing a husk press over the corn husk. The husk press has three guide members which are disposed along three adjacent edges of a flat plate, with no guide member on the fourth edge, thus also forming a u-shaped structure with the open end facing the user. The flat plate has a template opening through which a portion of masa may be deposited onto the surface of the corn husk with a spreading tool, leaving a uniform thickness of masa with a single motion. The device allows tamales to be made quickly with a uniform shell thickness and easy clean up.

### CROSS-REFERENCE TO RELATED APPLICATIONS

U.S. Provisional Application No. 61/281,943 for this invention was filed on Nov. 25, 2009 and U.S. Provisional Application No. 61/317,887 for this invention was filed on Mar. 26, 2010 Apr. 22, 2009, for which applications this inventor claims domestic priority.

### BACKGROUND OF THE INVENTION

The present invention relates generally to methods and devices utilized in the making of food products, and more specifically to methods and devices utilized for preparation of foods having an outer shell of dough which is rolled around a filling. In particular, the present apparatus and method may be utilized for quickly and neatly applying a layer of dough, such as masa, to a wrapping material, such as a sheet of corn husk, such that a layer of dough having a uniform shape and thickness is applied to the wrapping material. The present apparatus has applicability with respect to other types of food products in addition to tamales. Any food product having an outer layer of dough wrapped around a filling might utilize the present apparatus and method. However, the present invention and method are anticipated to have particular utility in the preparation of tamales, specifically the application of masa to a corn husk for preparation of tamales. Therefore, instead of utilizing the broader terms “dough” and “wrapping material”, the terms “masa” and “corn husk” are used hereinafter. However, it is to be appreciated that the method and apparatus have utility in the preparation of other food products, and the present application should not be limited by the specific reference to the applicability of the invention to the preparation of tamales.

Tamales are made by first applying a layer of dough or masa to an outer wrapping material, typically corn husk which has been soaked in water to make it soft and pliable. The masa is made from ground corn and has the consistency of paste or peanut butter. The basic method for making tamales generally comprises spreading a layer of masa on the inside of an outer wrapper, typically a corn husk. By its nature, the corn husk attempts to return to its cylindrical or tubular configuration, so it must be flattened and held in place while a layer of masa is spread upon it. Once the masa is spread upon the corn husk, filling such as meat, sauce, and other ingredients are placed on the masa, and the corn husk rolled with the mixture on the inside. The rolled tamales are thereafter steamed to cook the masa.

It is common to make a number of tamales at a single time. One of the more difficult tasks in making the tamales is applying the masa to the corn husk in a consistent and efficient manner, such that the completed tamales have a masa outer layer which is generally uniform in thickness and length. This can be particularly difficult when it is desired to make a large quantity of tamales. As stated above, the corn husks will return to their natural shape unless held in place, such that it is necessary to hold the corn husks in a flat position while a layer of masa is applied to the corn husk. Because of the sticky consistency of the masa, it can end up all over the work surface, the various appliances and working surfaces utilized in the process, and the people making the tamales. Thus, clean up can also be labor intensive. Obtaining a consistent thickness of masa for a batch of tamales is primarily a result of trial and error and dependent upon the skill and experience of the cook. While various devices have been developed which simplify the process, such as templates which are placed over the corn husk, or specialty spreaders, there is not a known device which allows the efficient spreading of a consistent layer of masa over a corn husk in a single swipe of the spreader, where the process may be repeated with a minimal amount of waste and mess.

### SUMMARY OF THE INVENTION

The disclosed method and apparatus meet the need described above by providing a device which provides a rectangular or square portable table having a top surface comprising a first area for holding a volume of masa, or other dough, and a second area for placing an outer wrapping material, such as a corn husk. Disposed within the first area is a masa storage compartment. The masa storage compartment may comprise three retention members for retaining the masa, where the retentions members are arranged, with respect to the position of the user, in an upside-down U-shaped configuration. A top retention member The portable table further comprises a corn husk disposition surface, which is adjacent to the masa storage compartment, upon which a corn husk, or other suitable wrapping material, is repeatedly placed for each tamale to be made. The device further comprises a husk press, which is placed over the husk disposition surface, and thus over a corn husk which is placed upon the corn husk disposition surface. The husk press three guide members disposed on three adjacent edges of a flat plate, with no guide member on the fourth edge, thereby defining a husk press opening. As with the masa storage compartment, the husk press is configured in a U-shape. The husk press is disposed upon the corn husk disposition surface such that the orientation of the husk press opening is the same as that of the storage compartment opening of the masa storage compartment.

Various design templates may be utilized with the husk press to create colored designs in the masa shell of the tamales. When the templates are utilized, colored masa is first deposited, using a desired design template, onto the corn husk. After the designs have been placed on the corn husk, the template is removed and a layer of the general masa dough applied on the corn husk, over the previously deposited colored masa designs. When completed, the finished tamales have fanciful designs on the outside of the masa shell.

### DESCRIPTION OF THE DRAWINGS

FIG. 1 shows a perspective view of all of the elements of an embodiment of the disclosed apparatus.

FIG. 2 shows a perspective view, showing masa M disposed within the reservoir of the preparation table, with the husk press lifted and a piece of corn husk placed below the husk press.

FIG. 3 shows a perspective view of an embodiment of the disclosed apparatus with masa disposed within the reservoir of the preparation table, the husk press in place over a sheet of corn husk, and a spreader ready to be utilized.

FIG. 4 shows the spreader being utilized to spread masa over the corn husk, the spreader fitting tightly within the guides of the husk press.

FIG. 5 shows a layer of masa M′ placed on the corn husk, showing how excess masa has been removed from the husk press by the spreader.

FIG. 6 shows the husk press lifted off of the corn husk, showing how a layer of masa has been neatly placed on the corn husk.

FIG. 7 shows a template which may be placed within the opening of the husk press to create designs on the outside of a tamale shell.

FIG. 8 shows how the template is utilized to create designs on the outside of a tamale shell.

FIG. 9 shows the designs which deposited on the corn husk utilizing the template shown in FIG. 7.

FIG. 10 shows the bottom side of the template shown in FIG. 7.

FIGS. 11-14 show examples of alternative templates which may be utilized to create designs on the outside of a tamale shell.

### DETAILED DESCRIPTION OF THE EMBODIMENTS

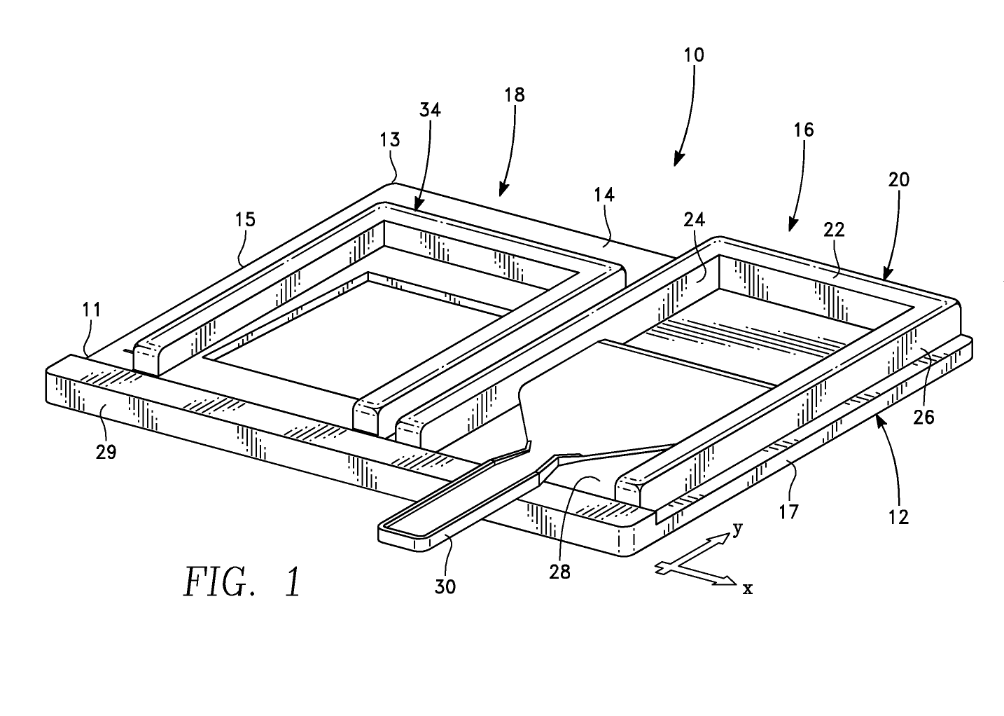

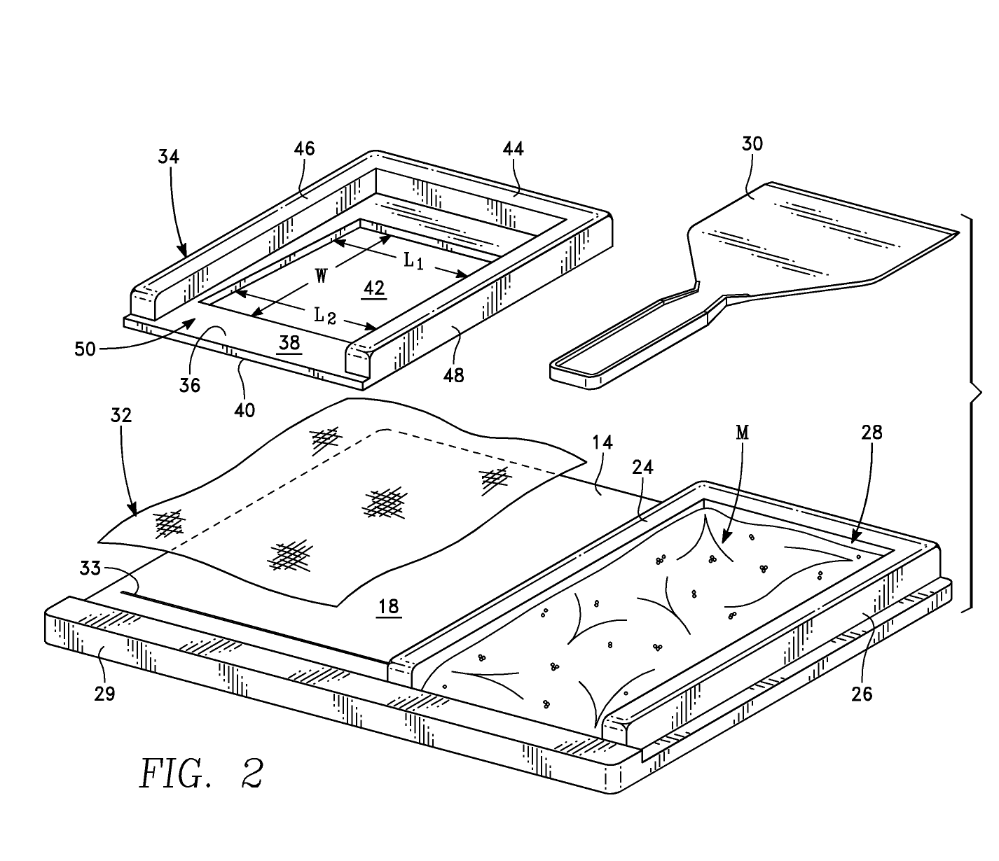

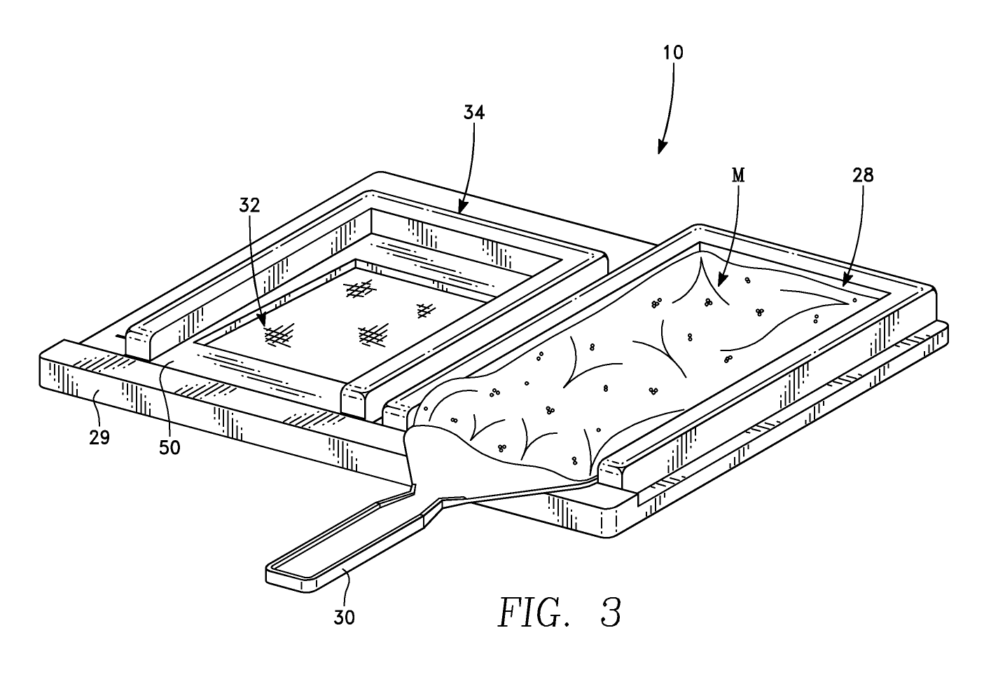

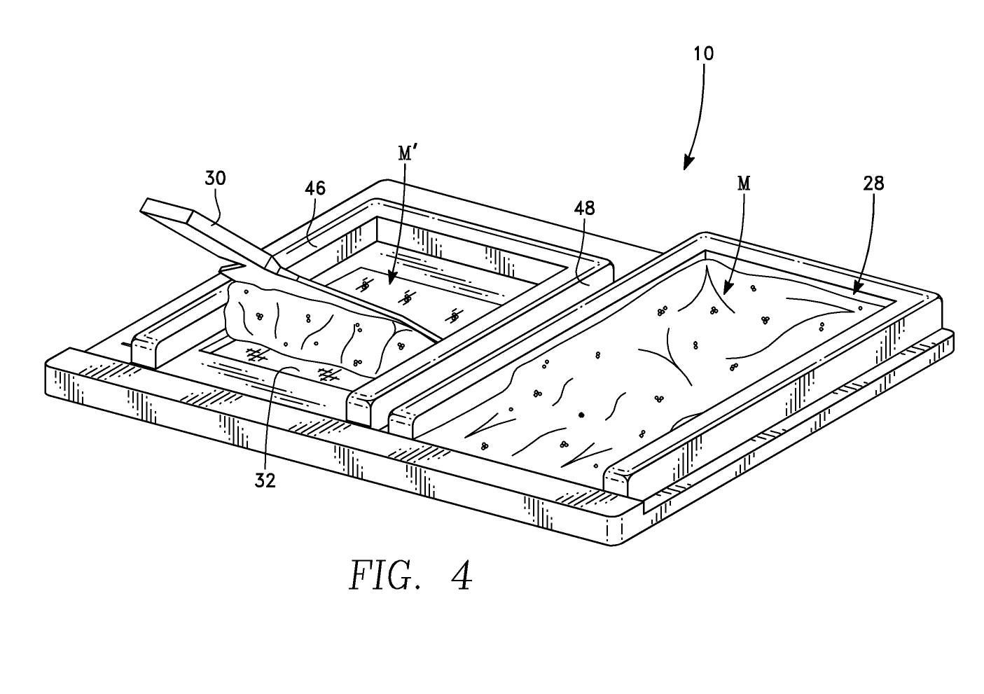

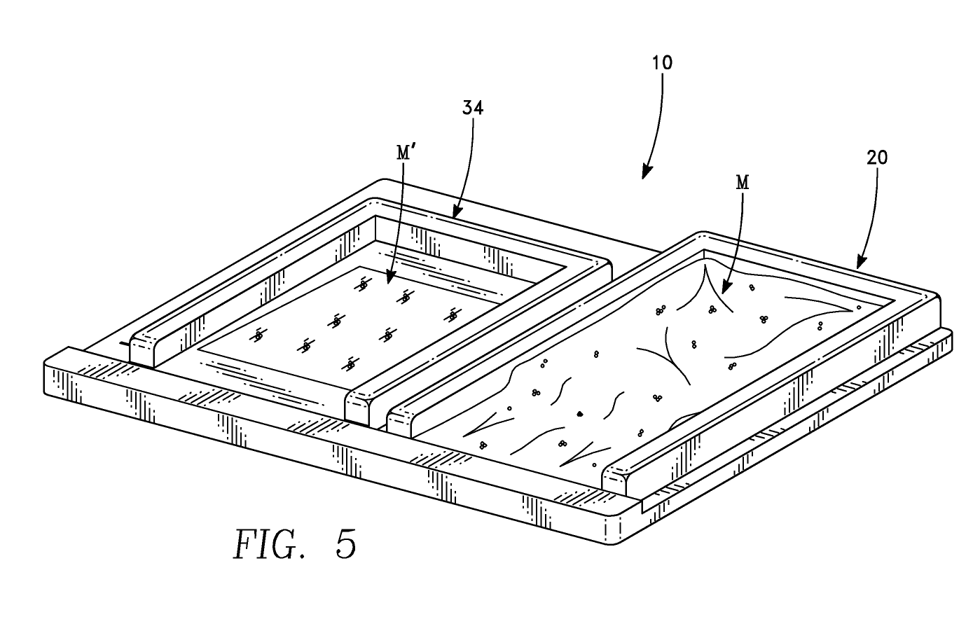

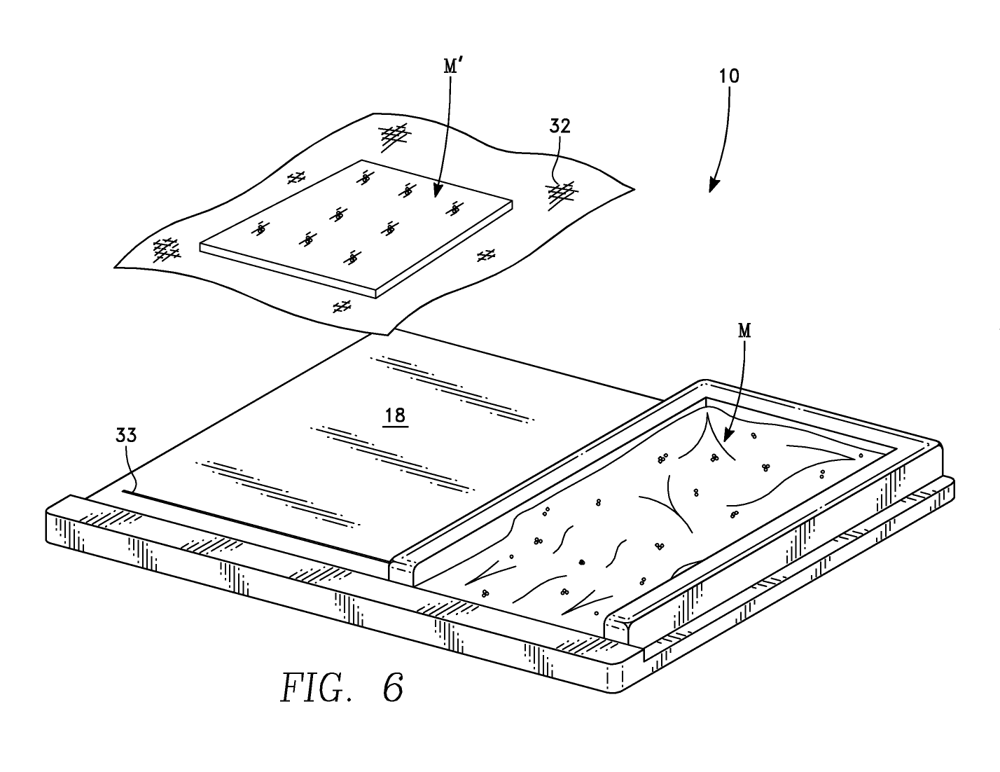

Referring now to the drawings, FIG. 1 shows the basic elements of an embodiment of the apparatus 10. As shown in FIG. 1, the apparatus 10 comprises a rectangular or square portable table 12 having a top surface 14. Top surface 14 comprises a front edge 11, a back edge 13, a left side 15, and a right side 17. Top surface 14 further comprises a first area 16 for holding a volume of masa, or other dough, and a second area 18 for placing an outer wrapping material, such as a corn husk. While a variety of dimensions may be utilized for the portable table, the inventor herein has found that a total length of 17½ inches by a width of 12 inches provides a workable surface area, where the first area is 7½ inches long by 11 inches wide and the second area is 10 inches long by 11 inches wide. The nominal height of the portable table may be ⅜ inches. For purposes of uniformity, unless stated otherwise, the terms “length” and “width” shall all refer to the same axial coordinates—that is, length shall refer to a dimension along the x-axis, as shown in FIG. 1, and width shall refer to a dimension along the y-axis as shown in FIG. 1.

Disposed upon the first area 16 is a dough or masa storage compartment 20. The masa storage compartment 20 is capable of retaining a volume of masa M or other type of dough. The masa storage compartment 20 may comprise three retention members 22, 24, 26 for retaining the masa or dough, where the retentions members may be arranged in a U-shaped configuration. The member 22 forming the bottom of the “U” is hereinafter referred to as the “back member,” the two parallel members 24, 26 are hereinafter referred to as the “side members,” and the side having no retention member is hereinafter referred to as the storage compartment opening 28, which is oriented toward the front edge 11. The three retention members may have a height of 13/16 inches. The masa storage compartment 20 is preferably dimensioned such that its width, that is the dimension between the two side members 24, 26, is slightly less than the width of spreading device 30 may be utilized with the device for removing the masa or dough from the masa storage compartment 20 and spreading it on a corn husk 32. This feature—the relationship of the width between the two side members 24, 26 and the width of the spreading device 30—allows a quantity of masa to be removed from the storage compartment 20 with one swipe of the spreading device between the parallel side members and removed through the storage compartment opening 28. A suitable width for the width between the two side members 24, 26 has been found to be six inches.

The portable table 12 further comprises a second area 18 for placing an outer wrapping material, such as a corn husk, hereinafter referred to as the corn husk disposition surface 18 which is adjacent to the masa storage compartment 20. A corn husk 32, or other suitable wrapping material, is placed, one at a time, for each tamale being made. The corn husk disposition surface 18 may comprise such indicia as are helpful to the proper placement of the corn husk 32, such as scribed lines 33 indicating the placement of the corn husk.

The device further comprises a husk press (also referred to as a “wrapper press”) 34, which, when desired, is placed over the husk disposition surface 18, and thus over a corn husk 32, or comparable tamale wrapping material. The removable husk press 34 comprises a flat plate 36 having a top surface 38 and a bottom surface 40, with a template opening 42 extending from the top surface to the bottom surface. Template opening 42 may have a top length L1 of 4½ inches, a bottom length L2 of 5½ inches, and a width W of 5½ inches. The thickness of flat plate 36 controls the thickness of the masa shell of the tamale. While this dimension may be varied according to taste, the inventor herein prefers a thickness of 3/16 inch.

The husk press 34 further comprises three guide members 44, 46, 48 disposed on three adjacent edges of the flat plate 36, with no guide member on the fourth edge. As with the masa storage compartment 20, the husk press 34 is configured in a U-shape. The guide member 44 forming the bottom of the “U” is hereinafter referred to as the “back guide member,” the two parallel guide members 46, 48 are hereinafter referred to as the “side guide members,” and the side having no guide member is hereinafter referred to as the husk press opening 50. The husk press 34 may have a total length of 7½ inches and a total width of 8¾ inches. The three guide members 44, 46, 48 may each have a width of ¾ inches

The husk press 34 may be disposed upon the corn husk disposition surface 18 with the husk press opening 50 abutting either the front edge 11 or the elevated edge piece 29, such that the orientation of the husk press opening is the same as that of the storage compartment opening 28 of the masa storage compartment 20. The husk press opening 50 will preferably have the same dimensions as storage compartment opening 28 of the masa storage compartment 20. The portable table 12 may also comprise an elevated edge piece 29 which extends along the entire front edge 11 of the portable table, including along the storage compartment opening 28, thus providing a slight lip at the storage compartment opening of the storage compartment 20 to retain masa on the portable table and also keep the husk press 34 in position. The elevated edge piece 29 may have a height of ⅜ inches above top surface 14.

It is to be appreciated that while various suitable dimensions have been stated herein for various elements of the apparatus, these may be changed accordingly. However, for the device to function as intended, the dimensions of the husk press opening 50 and the storage compartment opening 28 will normally be the same, with the width of the spreading device 30 just slightly smaller, allowing the spreading device to move between the two parallel members 24, 26 and the two parallel guide members 46, 48. Maintaining the dimensions in this manner allows the spreading device 30 to acquire on its blade the proper width of a masa M when passed between the two parallel members 24, 26 of the masa storage compartment 20, and to swipe this same load of masa through the two parallel guide members 46, 48 of the husk press 34. When swiped through the two parallel guide members 46, 48, a thickness of masa M′ will be deposited through the template opening 42 and upon the surface of the corn husk 32. As the spreading device 30 is scraped along the top surface 38 of the flat plate, any excess masa will be removed, and may be redeposited into the masa storage compartment. The masa remaining upon corn husk 32 will have the approximate thickness of flat plate 36, which may be approximately 3/16 inch.

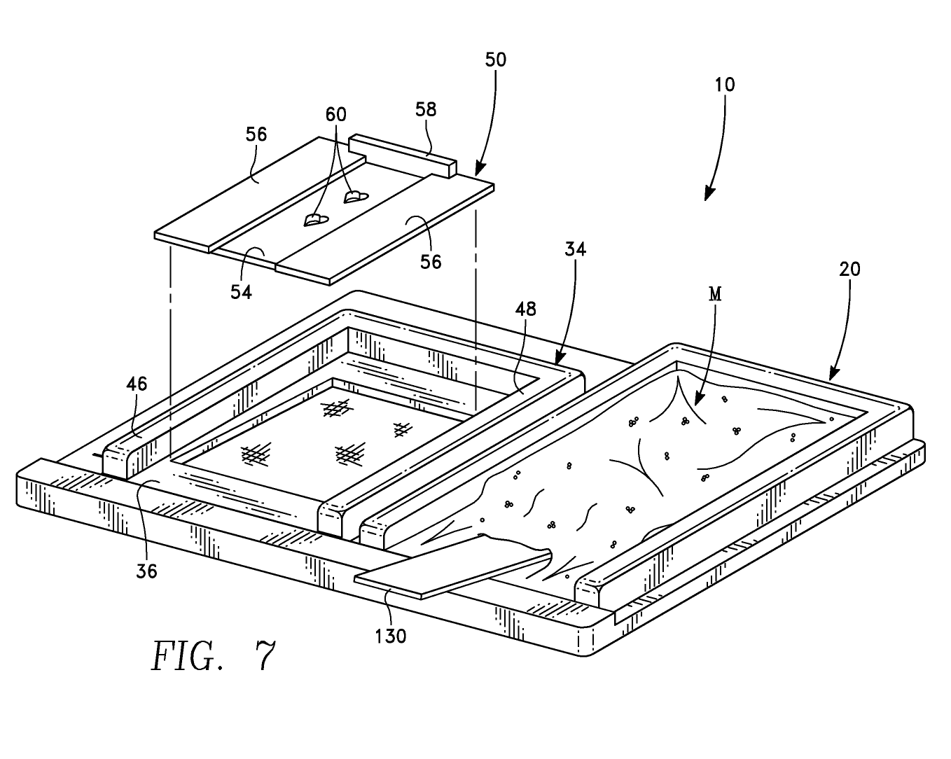

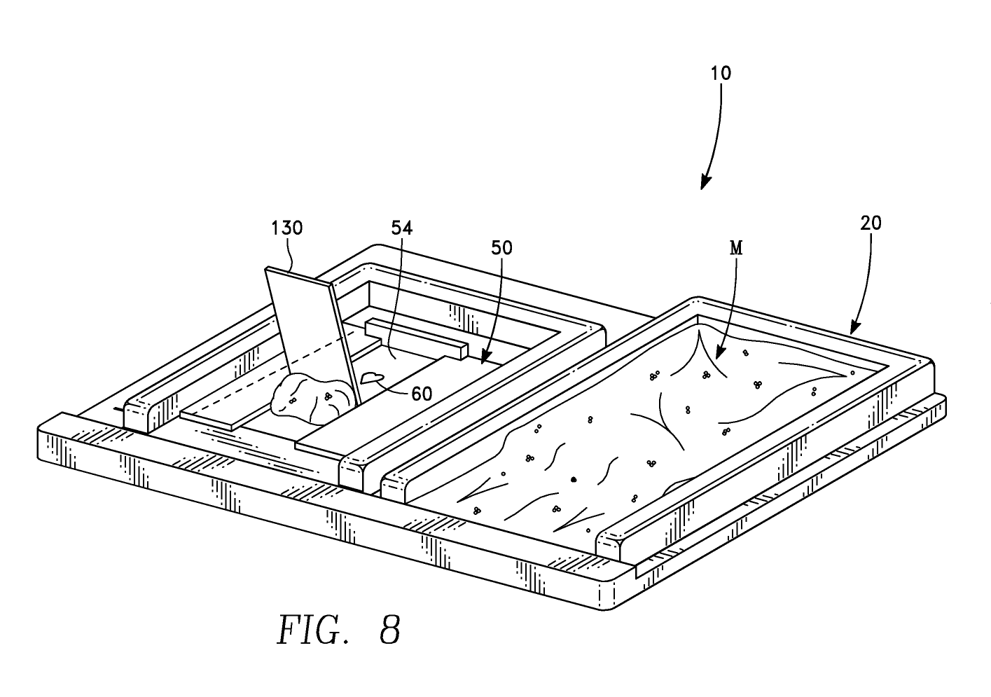

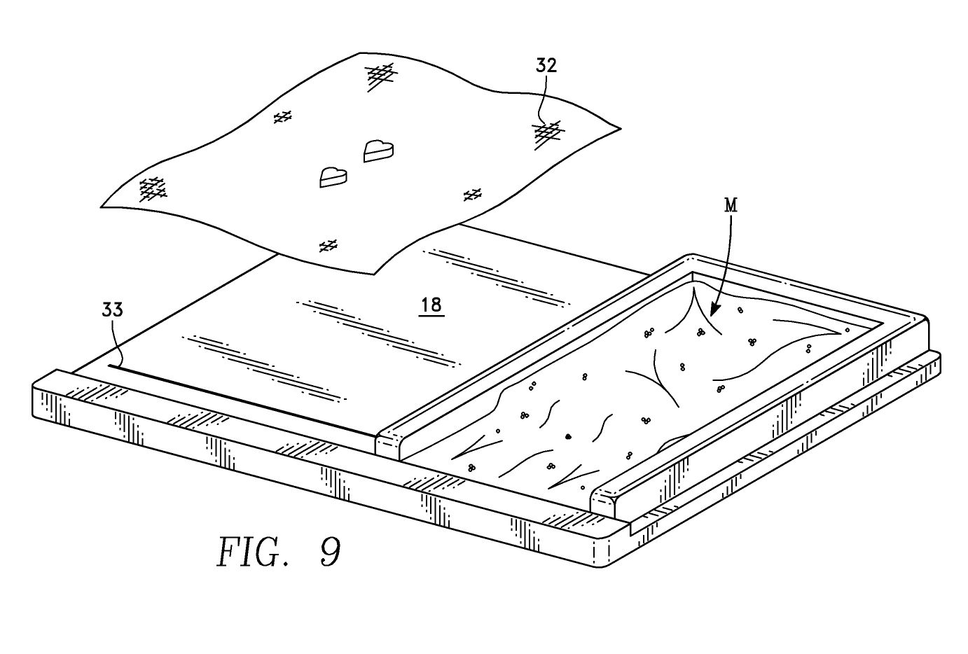

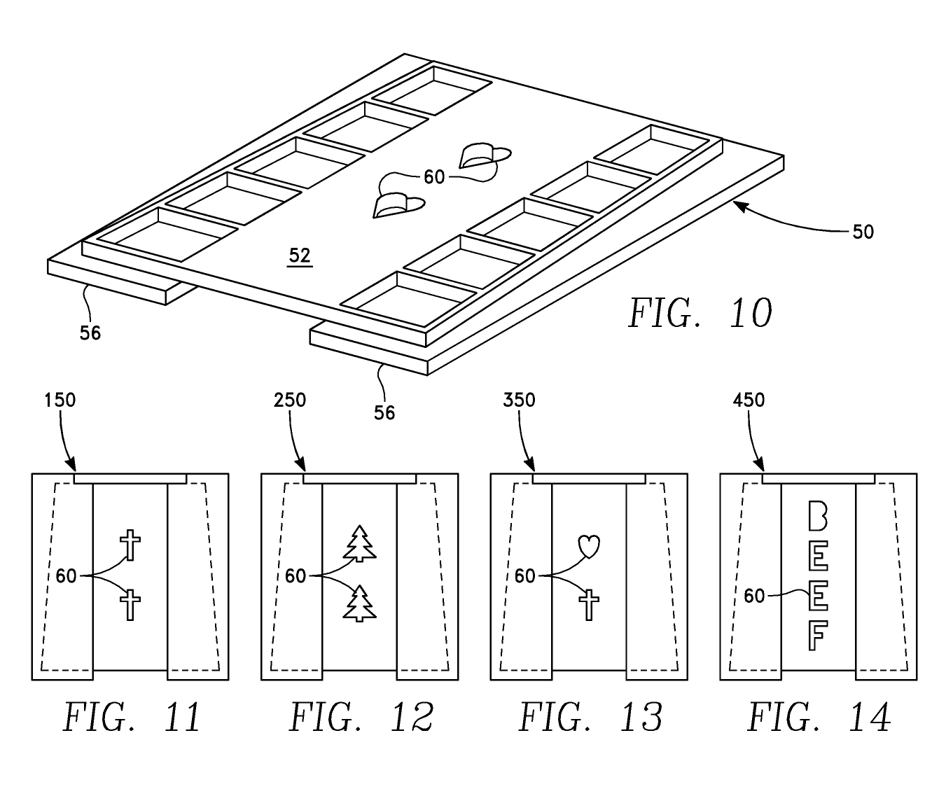

FIGS. 7-14 show an optional ornament insert 50 may be utilized with embodiments of the disclosed apparatus 10. Ornament insert 50 comprises plate 52 which has a channel 54 formed between side pieces 56. Ornament insert 50 may further comprise handle 58. Ornament insert 50 is sized to fit between the two parallel guide members 46, 48 and placed over flat plate 36. Insert 50 comprises one or more apertures 60 which penetrate entirely through plate 52. The apertures 60 are in the shape of an ornamental design, which may include the different designs shown in FIGS. 10-14, which show various embodiments of the ornament insert 50, 150, 250, 350, 450. As shown in FIGS. 10-13, the designs may be purely ornamental, such as hearts, crosses, and trees. Alternatively, as shown in FIG. 14, the designs may be functional and contain words. For example, as indicated in FIG. 14, the design may indicate the type of filling within the tamale, such as “beef” shown in FIG. 14, or other types of filling such as chicken, chile verde, etc.

The optional ornament inserts are utilized in the following manner in order to create the ornamental design on the shell of the tamale. A certain amount of colored masa is placed within masa storage compartment 20. The only requirement for the color is that it have sufficient contrast in color from the color used for the overall tamale shell. Ornament insert 50 is placed between the two parallel guide members 46, 48 and placed over flat plate 36. As indicated in FIG. 7, a modified spreading device 130 is used to obtain a quantity of the colored masa. Modified spreading device 130 preferably has a width which is slightly smaller than the width between side pieces 56, such that the modified spreading device will slide in channel 54. With a corn husk 32 placed upon the husk disposition surface 18, the colored masa is applied through apertures 60, through template opening 42 and onto the corn husk 32. Any remaining colored masa is removed from the masa storage compartment and replaced with masa of a contrasting color. The ornament insert 50 is lifted off of the flat plate 36. Maza is thereafter applied in the fashion described above, where spreading device 30 is utilized to acquire on its blade a portion of masa M. The spreading device, with the load of masa, is swiped through the two parallel guide members 46, 48 of the husk press 34. When swiped through the two parallel guide members 46, 48, a thickness of masa M′ is deposited through the template opening 42 and upon the surface of the corn husk 32, overlying the colored masa forming the artistic design. As before, as the spreading device 30 is scraped along the top surface 38 of the flat plate, any excess masa will be removed, and may be redeposited into the masa storage compartment. Thus deposited onto the corn husk will be the ornamental designs formed by the colored masa, with a shell layer of masa overlying the designs. Because the corn husks are generally not opaque, the designs will be somewhat visible through the corn husk.

While the above is a description of various embodiments of the present invention, further modifications may be employed without departing from the spirit and scope of the present invention. Thus the scope of the invention should not be limited according to these factors, but according to the following appended claims.

What is claimed is:

1. An apparatus for preparing tamales comprising:
a top surface defined by a front edge, a back edge, a left side, and a right side, the top surface further comprising a first area and a second area, wherein a dough storage compartment is disposed within the first area and the second area comprises a wrapper disposition surface, wherein the dough storage compartment comprises three dough retention members, the three dough retention members comprising a back member and two parallel side members, which are joined by the back member, wherein the configuration of the back member and the two parallel side member defines a storage compartment opening having a first width, the storage compartment opening facing the front edge;
a wrapper press which may be removably placed over the wrapper disposition surface over a tamale wrapper, the wrapper press comprising a flat plate having a top surface and a bottom surface, with a template opening extending from the top surface to the bottom surface, wherein the wrapper press further comprises three guide members disposed on three adjacent edges of the flat plate, wherein the three guide members comprise a back guide member and two parallel guide members which are joined by the back guide member, wherein the configuration of the back guide member and the two parallel guide members defines a wrapper press opening having a second width, the wrapper press opening facing the front edge; and
a hand held dough spreading device having a blade, the width of the blade slightly less than the wrapper press opening.

2. The apparatus of claim 1 wherein the wrapper disposition surface comprises means for aligning the tamale wrapper.

3. The apparatus of claim 2 wherein the means for aligning the tamale wrapper comprise scribed lines which indicate the placement of the tamale wrapper.

4. The apparatus of claim 1 wherein the width of the storage compartment opening is equivalent to the width of the wrapper press opening.

5. The apparatus of claim 1 wherein the template opening in the wrapper press has a top length and a bottom length and the top length is larger than the bottom length.

6. The apparatus of claim 5 wherein the top length is approximately 4½ inches and the bottom length is approximately 5½ inches.

7. The apparatus of claim 5 wherein the template opening has a uniform width.

8. The apparatus of claim 1 wherein the table member further comprises an edge piece which extends along the front edge

9. The apparatus of claim 1 further comprising an insert which is placed over the top surface of the flat plate, wherein the insert is disposed between the two parallel guide members, wherein the insert comprises an aperture in the shape of an ornamental design.

10. The apparatus of claim 9 wherein the ornamental design is selected from the group consisting of a cross, a tree, a heart, a letter of the alphabet, or any combination thereof.

11. A method of making tamales comprising the steps of:
placing masa within a masa storage compartment of a table member, wherein the table member comprises a top surface comprising a first area and a second area adjacent to the first area, wherein the masa storage compartment is disposed within the first area and the second area comprises a corn husk disposition surface, and the masa storage compartment comprises a storage compartment opening;
placing a corn husk upon the corn husk disposition surface;
placing a husk press over the corn husk, wherein the husk press comprises a flat plate having a top surface and a bottom surface, with a template opening extending from the top surface to the bottom surface, the husk press further comprising three guide members comprising a back guide member and two parallel guide members which are joined by the back guide member, wherein the configuration of the back guide member and the two parallel guide members define a husk press opening;
gathering a portion of the masa contained within the masa storage compartment on a spreading tool;
swiping the portion of masa on the spreading tool through the template opening, thereby depositing a layer of masa on the corn husk through the template opening;
lifting the husk press from the corn husk;
removing the corn husk from the corn husk disposition surface;
spreading a filling on the layer of masa on the corn husk; and
rolling the corn husk to form a tamale.

12. The method of claim 11 wherein the corn husk disposition surface comprises means for aligning the corn husk.

13. The method of claim 12 wherein the means for aligning the corn husk comprise scribed lines which indicate the placement of the tamale wrapper.

14. The method of claim 11 wherein the width of the compartment opening is equivalent to the width of the husk press opening.

15. The method of claim 11 wherein the template opening in the wrapper press has a top length and a bottom length and the top length is larger than the bottom length.

16. The method of claim 15 wherein the top length is approximately 4½ inches and the bottom length is approximately 5½ inches.

17. The method of claim 15 wherein the template opening has a uniform width.

18. The method of claim 17 wherein the template opening has a uniform width of 5½ inches.

19. A method of making tamales comprising the steps of:
placing colored masa within a masa storage compartment of a table member, wherein the table member comprises a top surface comprising a first area and a second area adjacent to the first area, wherein the masa storage compartment is disposed within the first area and the second area comprises a corn husk disposition surface, and the masa storage compartment comprises a storage compartment opening;
placing a corn husk upon the corn husk disposition surface;
placing a husk press over the corn husk, wherein the husk press comprises a flat plate having a top surface and a bottom surface, with a template opening extending from the top surface to the bottom surface, the husk press further comprising three guide members comprising a back guide member and two parallel guide members which are joined by the back guide member, wherein the configuration of the back guide member and the two parallel guide members define a husk press opening;
placing an insert over the top surface of the flat plate, wherein the insert is disposed between the two parallel guide members, wherein the insert comprises an aperture in the shape of an ornamental design;
gathering a portion of the colored masa contained within the masa storage compartment on a spreading tool;
swiping the portion of colored masa on the spreading tool through the template opening, thereby depositing a layer of masa on the corn husk through the aperture;
replacing any colored masa within the masa storage compartment with a different color of masa;
gathering a portion of the masa contained within the masa storage compartment on a spreading tool;
swiping the portion of masa on the spreading tool through the template opening, thereby depositing a layer of masa on the corn husk through the template opening;
lifting the husk press from the corn husk;
removing the corn husk from the corn husk disposition surface;
spreading a filling on the layer of masa on the corn husk; and
rolling the corn husk to form a tamale.

20. The method of claim 19 wherein the ornamental design is selected from a group consisting of a cross, a tree, a heart, a letter of the alphabet, or any combination thereof.
